(19) United States
(12) Patent Application Publication
(10) Pub. No.: US 2026/0027852 A1
(43) Pub. Date: Jan. 29, 2026

(54) MECANUM WHEEL

(71) Applicant: Locus Robotics Corp., Wilmington, MA (US)

(72) Inventors: John Pearlman, Holden, MA (US); Sarah Forman, Watertown, MA (US); Daniel McBride, Dracut, MA (US); David Nastuk, Carlisle, MA (US); Andrew Mertinooke, Bedford, NH (US); Brendan Patrick Collins, Manchester, NH (US); Seth Edwards Allen, Newton, NH (US)

(21) Appl. No.: 19/277,959

(22) Filed: Jul. 23, 2025

Related U.S. Application Data
(63) Continuation-in-part of application No. 18/785,589, filed on Jul. 26, 2024.

(51) Int. Cl. B60B 19/00; B60B 19/12; F16C 19/46

(52) U.S. Cl. CPC B60B 19/003; B60B 19/12; F16C 19/46; B60B 2380/16

(57) ABSTRACT

A mecanum wheel includes a first wheel frame having a circumference and a plurality of first mounting mechanisms spaced about the circumference. There is a second wheel frame having a circumference and a like plurality of second mounting mechanisms spaced about the circumference. There are a plurality of roller units, each having a roller surface and a hollow center cavity. There is an axle disposed in the hollow center cavity of each roller, and a first end of the axle is connected a first mounting mechanisms and the second end of each axle is connected to the second mounting mechanism. The second end of each axle includes a notched portion.

### CROSS REFERENCE TO RELATED APPLICATION

This application is a continuation-in-part of U.S. patent application Ser. No. 18/785,589, filed Jul. 26, 2024, which is incorporated herein by reference in its entirety.

### TECHNICAL FIELD

The present invention relates to improvements in the design of omnidirectional wheels and more particularly to the design of mecanum wheels for use with robots.

### BACKGROUND ART

Robots working in factories, wheelchairs moving into place on a bus, moon-landers and other motorized vehicles all need to move omnidirectionally in a compact and facile manner. The mecanum wheel, patented in the US in 1975 as U.S. Pat. No. 3,876,255 provides a widely adopted solution to this problem. A vehicle equipped with four mecanum wheels can, by independently varying the speed and rotational direction of each wheel, move in a straight line at any angle from its current position.

Despite their many advantages, mecanum wheels as currently designed may suffer from a loosening of component parts, resulting in shimmying and creating noise and, in some cases, failure of the mecanum wheel. A need exists for improved designs to address these and related issues.

### SUMMARY OF THE EMBODIMENTS

According to an embodiment of this disclosure, there is a mecanum wheel including a first wheel frame having a circumference and a plurality of first mounting mechanisms spaced about the circumference. There is a second wheel frame having a circumference and a like plurality of second mounting mechanisms spaced about the circumference; each of the plurality of second mounting mechanisms having a corresponding first mounting mechanism. There are a plurality of roller units, each having a roller surface and a hollow center cavity and an axle disposed in the hollow center cavity. The axle has a first end connected to one of the first mounting mechanisms of the first wheel frame and the axle has a second end connected to the corresponding second mounting mechanisms of the second wheel frame. The second end of each axle includes a notched portion.

In another embodiment one or more of the following features may be included. Each notched portion has a length extending from a first position along a length of the axle to the second end of the axle. The length of the notch portion may be 5% or less of the length of the axle. The notched portion may include a substantially flat surface extending along the length of the notched portion and across a diameter of the axle at the first position and wherein a center of the substantially flat surface at the first position may be positioned at a longitudinal axis of the axle. The notched portion may have a notch depth extending radially from the center of the substantially flat surface at the first position to an outside surface of the axle. The notch depth may be equal to a radius of the axle. The notched portion may include an outer curved surface extending away from and along the length of the substantially flat surface; and wherein the outer curved surface is chamfered along at least a portion of the length of the notched portion. Each second mounting mechanism may include an internal hollow region to receive the second end of the axle. The internal hollow region may include a first hollow section which is cylindrical in shape and may have a diameter substantially equal to the diameter of the axle and a second hollow section has an interior surface shaped to receive an exterior surface of the notched portion of the axle. When the notched portion of the axle is disposed in the second hollow section, a portion of the axle may be disposed in the first hollow section; and the substantially flat surface of notched end portion may be mated face-to-face with a substantially flat surface portion of the interior surface of the second hollow section. The first end of each axle may include an angled tip portion with a substantially flat surface.

In yet another embodiment one or more of the following features may be included. each first mounting mechanism may include an elastic compression piece having a first surface disposed on the substantially flat surface of the angled tip portion of the first end of the axle. Each first mounting mechanism may include a cover piece in contact with a second surface of the compression piece and configured to compress the compression piece against the substantially flat surface of the angled tip portion of the first end of the axle. The substantially flat surface of the angled tip portion of the first end of the axle may be parallel to an external surface the first wheel frame and the cover piece may be mounted on the external surface of the first wheel frame. There may be further included a first bearing structure mounted in a first cavity at a first end of the roller body and a second bearing structure mounted in a second cavity at a second end of the roller body. The first and second bearing structures may include a needle roller bearing disposed about the axle with an inner surface spaced from an outer surface of the axle in a radial direction forming a gap between the inner surface of the needle roller bearing and the outer surface of the axle. There may be a sleeve adapter disposed in the gap about the axle between and in contact with the inner surface of the needle roller bearing and the outer surface of the axle and there may be a thrust roller bearing disposed about the axle adjacent to and inside of the needle roller bearing in an axial direction, with an inner surface in contact with the outer surface of the axle.

According to yet another embodiment of this disclosure, there is a mecanum wheel with a first wheel frame having a circumference and a plurality of first mounting mechanisms spaced about the circumference. There is a second wheel frame having a circumference and a like plurality of second mounting mechanisms spaced about the circumference. Each of the plurality of second mounting mechanisms having a corresponding first mounting mechanism. There are a plurality of roller units, each having: a roller body with an outer surface and a central region. The central region includes a first cavity at a first end of the roller body, a second cavity at a second end of the roller body. There is an axle extending in an axial direction through the roller body, including through the first cavity and the second cavity. The axle is connected at a first end to one of the first mounting mechanisms of the first wheel frame and at a second end to the corresponding second mounting mechanisms of the second wheel frame. There is a first bearing structure mounted in the first cavity and a second bearing structure mounted in the second cavity. The first and second bearing structures include a needle roller bearing disposed about the axle with an inner surface spaced from an outer surface of the axle in a radial direction forming a gap between the inner surface of the needle roller bearing and the outer surface of the axle. There is a sleeve adapter disposed in the gap about the axle between and in contact with the inner surface of the needle roller bearing and the outer surface of the axle. There is a thrust roller bearing disposed about the axle adjacent to and inside of the needle roller bearing in an axial direction, with an inner surface in contact with the outer surface of the axle.

In another embodiment one or more of the following features may be included. The first bearing structure includes a first lip seal disposed about a circumference of a first end of the needle roller bearing proximate an opening of the first cavity and wherein the second bearing structure includes a second lip seal disposed about a circumference of a first end of the needle roller bearing proximate an opening of the second cavity.

### BRIEF DESCRIPTION OF THE DRAWINGS

The foregoing features of embodiments will be more readily understood by reference to the following detailed description, taken with reference to the accompanying drawings, in which:

FIG. 1 provides a perspective view of a mecanum wheel with a design according to the prior art.

FIG. 2 provides a cross-sectional view of a roller in the mecanum wheel of FIG. 1.

FIG. 3 provides a perspective view of a mecanum wheel according to an aspect of the this disclosure.

FIG. 4 provides a cross-sectional view of a roller of the mecanum wheel of FIG. 3.

FIG. 5 provides a cut-out view of a portion of a first mounting mechanisms for the roller of the mecanum wheel according to this disclosure.

FIG. 6 depicts the external side of a mini-cover for the first mounting mechanism of FIG. 5.

FIG. 7 depicts the internal side of the mini-cover of FIG. 6.

FIG. 8 is a side view the rotor axle as shown in FIG. 4.

FIG. 9 is a perspective view of a compression piece according to an aspect of this disclosure for holding the axle in place.

FIG. 10 is an enlarged perspective view of a cylindrical recess and integrated washer of a second mounting mechanism according to an aspect of this disclosure

FIG. 11 is perspective view of an alternative axle design in accordance with another aspect of this disclosure.

FIG. 12A is perspective view of the axle of FIG. 11 mounted in a roller assembly.

FIG. 12B is another perspective view of the axle of FIG. 11 mounted in a roller assembly.

FIG. 13 is a cross-sectional of the notched portion of the axle partially inserted in a mounting mechanism according to another aspect of this disclosure.

FIG. 14 is a perspective view a roller assembly, including a partial cut-away view to depict the bearing structures according to another aspect of this disclosure.

FIG. 15 is a cross-section view of one of the bearing structures of FIG. 14.

FIG. 16 is a cross-section view of a bearing structure, including a cross-section view of the needle bearing with a sealing ring according to a further aspect of this disclosure.

FIG. 17 a cross-sectional view of a roller assembly with bearing structures according to FIGS. 15 and 16 and with an axle having one end with a notched portion and a second end with an angled tip portion.

### DETAILED DESCRIPTION OF SPECIFIC EMBODIMENTS

The disclosure and the various features and advantageous details thereof are explained more fully with reference to the non-limiting embodiments and examples that are described and/or illustrated in the accompanying drawings and detailed in the following description. Various aspects of the subject matter discussed in greater detail below may be implemented in any of numerous ways, as the subject matter is not limited to any particular manner of implementation. Examples of specific implementations and applications are provided primarily for illustrative purposes.

Unless otherwise defined, used, or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein. The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms “includes,” “including,” “comprises,” and “comprising” specify the presence of the stated elements or steps but does not preclude the presence or additional of one or more other elements or steps.

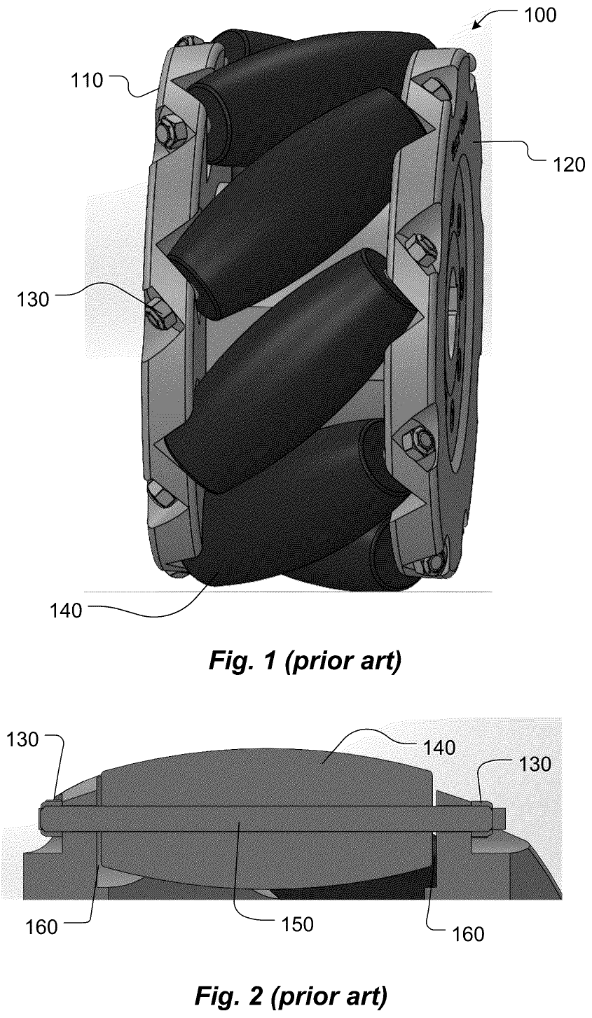

A prior art design of a mecanum wheel 100 is shown in FIGS. 1 and 2 to include a plurality of rollers 140 obliquely disposed between two wheel frames 110 and 120. Each wheel frame is a circular structure having a rim and the plurality of rollers 140 are disposed about the circumference of the frames. Each roller 140 is held in place by nuts 130 on either end of a roller axle (not visible in this view), affixing the axle to wheel frames 110 and 120 and allowing the rollers to freely rotate as mecanum wheel 100 turns.

A cross-sectional view of a portion of mecanum wheel 100 is shown in FIG. 2 depicting how nuts 130 are screwed onto each end of an axle 150 longitudinally disposed through a hollow central region of roller 140. According to this prior art design, nuts 130, which may be made of nylon, are screwed in place to retain axle 150 and hold the roller 140 in position on the wheel frames 110 and 120. Gaps 160 between bearings (not shown) on the roller 140 and the wheel frames 110 may be filled with washers of various sizes, in order to shim the rollers 140 to hold them securely in place.

However, due to the imprecision of the shims, axial play between the rollers 140 may result in movement and vibration of the roller 140 causing shaking, noise and a loosening of components. Over time the nuts may come off the axle and the axles may scrape against the ground causing them to wear and possibly break. These problems are eliminated with the mecanum wheel design of the present disclosure, which holds the rollers firmly in place without the need to fill gaps with washers. This eliminates shimmying, reduces noise, and eliminates the problem of nuts loosening and causing the axle and rollers to fail.

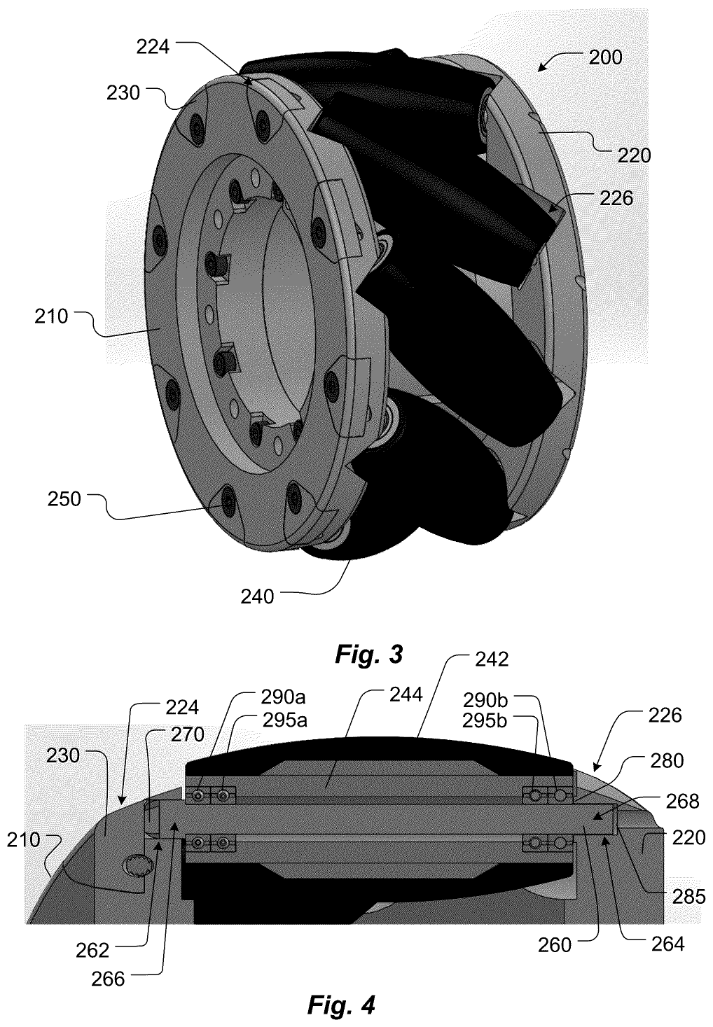

FIG. 3 depicts an embodiment of a mecanum wheel 200 according to the current disclosure. The wheel comprises a first wheel frame 210 and a second wheel frame 220 having a plurality of roller units 240 obliquely disposed between the two wheel frames 210, 220. The roller units 240 are mounted at a first end into a plurality of first mounting mechanisms 224 about the circumference of wheel frame 210 and they are mounted at a second end in a corresponding plurality of second mounting mechanisms 226 about the circumference of the wheel frame 220. Each of the first mounting mechanisms 224 includes a cover piece 230 affixed to wheel frame 210 via a screw 250 to lock the roller units in place, as described in more detail below.

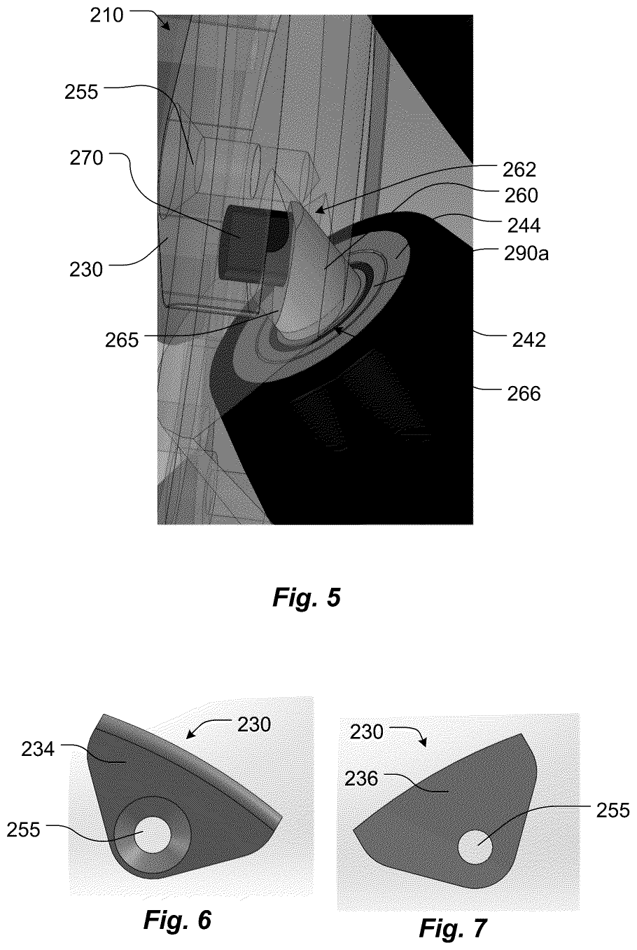

Referring to FIGS. 4 and 5, a more detailed depiction of mecanum wheel 200 is provided. In FIG. 4 a cross-sectional view of roller unit 240, affixed between wheel frames 210, 220 is shown. In FIG. 5 a close-up, transparent view of a portion of a first mounting mechanism 224 for the roller unit 240 is shown.

As depicted, roller unit 240 includes a roller surface 242 mounted on a roller support 244. In the center of roller support 244 and running longitudinally through the center of roller support 244 is a hollow center cavity through which an axle 260 is disposed. Axle 260 has a first end 262 extending outside of a first end 266 of the hollow center cavity and connected to one of the first mounting mechanisms 224 of the first wheel frame 210 and having a second end 264 extending outside of a second end 268 of the hollow center cavity and connected to the corresponding second mounting mechanisms 226 of the second wheel frame 220.

Continuing to refer to FIGS. 4 and 5, first end 262 of roller axle 260 in first mounting mechanism 224 receives an angled tip portion 265 with a substantially flat surface, on which is disposed a compression piece 270. The flat surface is substantially parallel with the cover piece 230 (as shown in FIG. 5) and an outer surface of wheel frame 210. According to this embodiment, one end of the axle 260 of each roller 240 is held in place by a compression piece 270, which may be constructed of an elastic material. The compression piece 270 is sandwiched between cover piece 230 and the substantially flat surface of the angled tip portion 265 of the axle 260. The compression piece 270 is fixed in place against the cover piece 230 by screw 250. The compression of the compression piece may be varied changing the durometer of the compression piece.

As can be seen in the cross-sectional view of FIG. 4, ball bearing set 290a/b are affixed to either end of roller support 244 in the hollow center cavity and are in contact with axle 260 to facilitate rotation of the roller unit 240 about axle 260. An additional set of ball bearings 295a/b are also affixed to roller support 244 inside of hollow center cavity and in contact with axle 260 to facilitate rotation of the roller unit 240. Ball bearing set 290a/b is located at the first end 266 and second end 268 of hollow center and ball bearing set 295a/b are positioned adjacent to and inside of ball bearing set 290a/b.

At first end 266 of hollow center cavity ball bearings 290a are in contact with a flange portion on first end 262 of axle 260 and second end 264 of axle 260 sits in a central concave region 285 of second mounting mechanisms 226. Ball bearings 290b are in contact with built in or integrated washer 280 which is more clearly depicted in FIG. 10. Turning the screw 250 so as to increase the compression of the compression piece 270 against the angled tip portion 265 of the axle 260, in turn pushes flange portion on first end 262 of axle 260 against the ball bearings 290a. This forces ball bearings 290b against the built-in or integrated washer 280, thereby firmly holding the roller 240 in place between frames 210 and 220 and eliminating shimmying, and the noise and loosening of components associated therewith.

FIGS. 6-10 show isolated embodiments of the individual components of the mecanum wheel 200 that is disclosed herein.

FIG. 6 depicts an embodiment of the external side 234 of the cover piece 230 against which the compression piece 270 pushes, showing the screw hole 255 into which a screw is inserted in order to tighten the cover piece 230 against the compression piece 270, thereby causing the compression piece 270 to exert pressure against the angled tip portion 265 of the rotor axle 260. According to some embodiments, an indentation on the external side 234 of the cover piece 230 allows the screw 250 to sit flush with the surface of the cover piece 230. FIG. 7 shows the internal side of the cover piece of FIG. 6. The internal side being the side which contacts the compression piece 270.

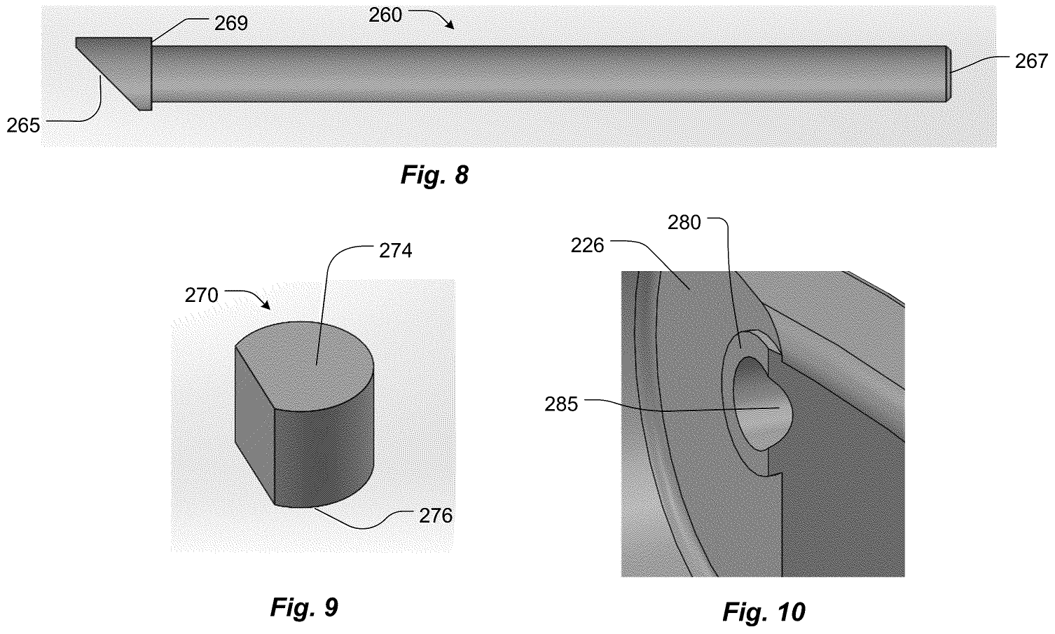

FIG. 8 depicts an embodiment of axle 260, which traverses the hollow center cavity of each roller unit 240. The angled tip portion 265 at one end allows the compression piece 270 to be held firmly in place against the cover piece 230. Angled tip portion 265 also provides an anti-rotation function (which eliminates the need for keyways, set screw, D profile, etc.) to fix axle 260 from rotating relative to 210 and 220

At the opposite end from the angled tip portion 265, the cylindrical end 267 of the axle 260 fits into a concave recess 285 in the second mounting mechanism 226, as described above and depicted in a close-up view in FIG. 10. As noted above, set of bearings 290b is pressed against the built-in washer 280, in a manner controllable by the cover piece screw 250.

FIG. 9 is an embodiment of compression piece 270 that may be sandwiched between the angled end of the rotor axle and the internal side of the cover piece. One surface 274 presses against the inner surface 236 of the cover piece 230, and the opposite surface 276 presses against the angled tip portion 265 of the axle 260.

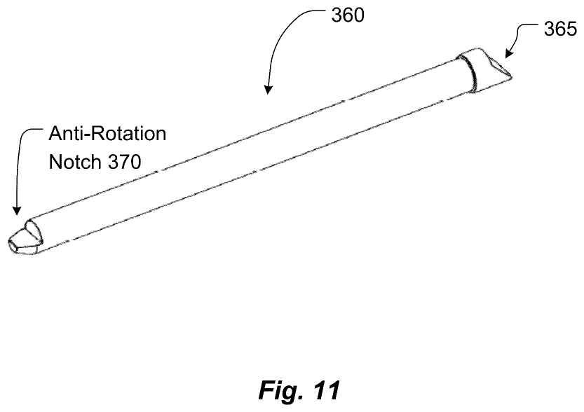

In FIG. 11, there is an alternative embodiment of axle 260 shown in FIG. 8. Here axle 360 includes at one end an angled tip portion 365, which may be the equivalent of angled tip portion of axle 260. However, at the other end of axle 360, there is included an anti-rotation notched portion 370 in place of the cylindrical end 267 of axle 260. While angled tip portion 265 provides an anti-rotation function, for larger and heavier robots and other vehicles, additional anti-rotation functionality may be required. It should be noted that for certain applications the anti-rotation notched portion 370 may be used without the angled tip portion 365 at the other end of axle 360, and a cylindrical end like end 267 or another axle end design may be used instead.

As described above with regard to FIG. 2, the mecanum wheel comprises a first wheel frame 210 and a second wheel frame 220 having a plurality of roller units 240 obliquely disposed between the wheel frames 210, 220. The roller units 240 are mounted at a first end into a plurality of first mounting mechanisms 224 about the circumference of wheel frame 210 and they are mounted at a second end in a corresponding plurality of second mounting mechanisms 226 about the circumference of the wheel frame 220. This embodiment may utilize such a mecanum wheel design, however, with different axles such as axle 365 shown in a perspective view in FIG. 11. Moreover, as will be described below, the second mounting mechanisms which will receive the anti-rotation notched portion at the end of the axle, will have a different design to receive the notched portion of the axle and in combination prevent rotation of the axle.

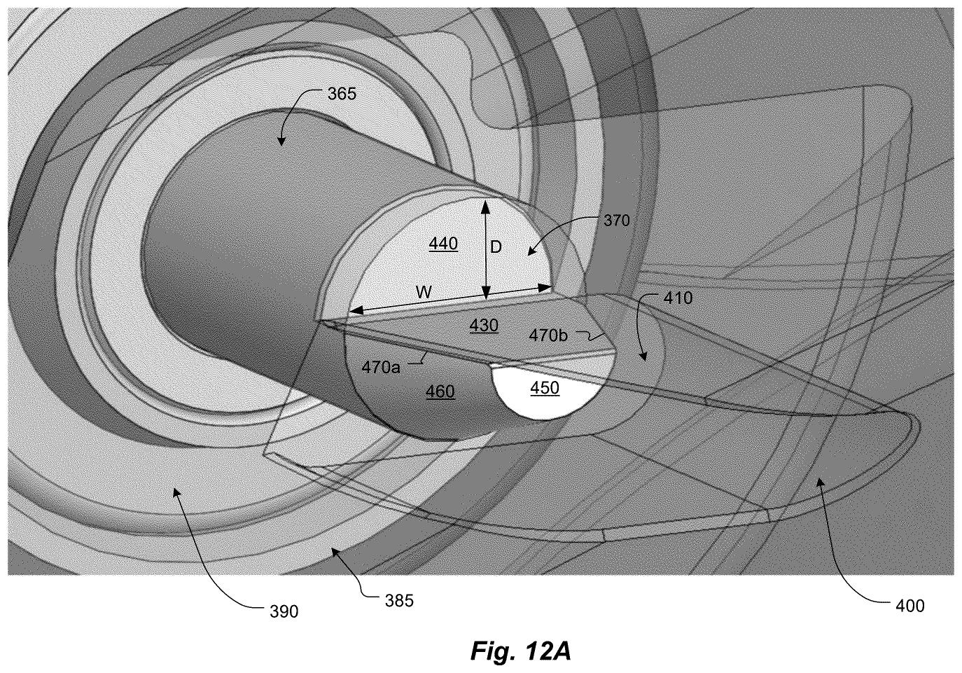

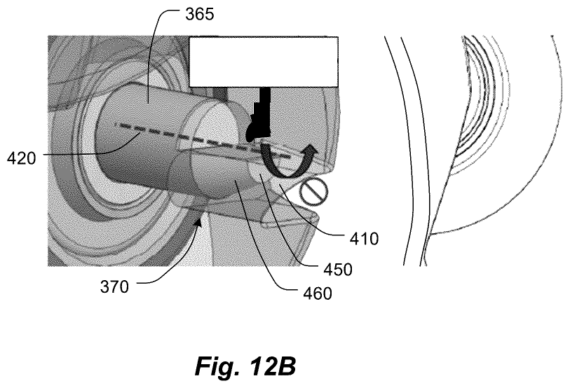

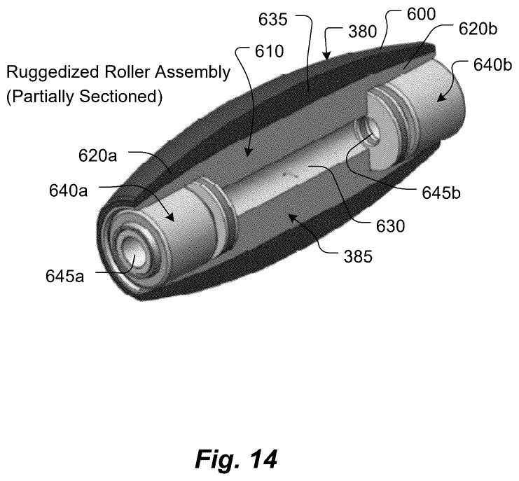

Referring now to FIGS. 12A and B, which depicts a larger perspective view of the second end of axle 365 and notched portion 370, with axle 365 installed in the hollow central cavity 385 of roller assembly 380. Also in the hollow central cavity 385 may be ball bearings and other components 390 (referenced in the aggregate) to support axle 365. Ball bearings and other components 390 are not described in detail with regard to this figure, but rather they are more clearly depicted in FIGS. 14-17 and described in detail below. These bearings and other components provide a ruggedized roller assembly design for larger and heavier vehicles. The ruggedized roller assembly in combination with the anti-rotation notched end of the axle are not required to be used together but may be particularly well suited for larger/heavier vehicles, including robots with larger support structures designed to carry heavier payloads. Another example of the components that may be in the roller cavity are shown in FIG. 4 and described above.

Continuing to refer to FIGS. 12A and B, a portion of one of the second mounting mechanisms 400, like second mounting mechanisms 226 of FIG. 2, but designed to receive notched portion 370, is shown in phantom. Notched portion 370 is shown inserted into a mating slot 410 in second mounting mechanism 400, which slot is sized and shaped to conform to the exterior shape of the notched portion 370 to allow it to be snugly received and prevent its rotation and hence the rotation of axle 365 about its longitudinal axis 420 as shown in FIG. 12B.

Notched portion 370 has a notch depth, D, which is ideally equal to the radius of a cross section of axle 365. As is shown in FIGS. 12A and B, the notch depth, D, extends radially from the center of the substantially flat surface 430 across width, W, in a direction perpendicular thereto to an outside surface of the axle. The center of substantially flat surface 430 is also positioned at a distance equal to the radius along notch face 440, which is semi-circular in shape. D need not be equal to the radius of the axle and may have a range of depths

With the notch depth equal to the radius, the greatest notch width, W, equal to the diameter of a cross section of axle 365 will be achieved and will provide the greatest amount of resistance to rotation when the axle 365 is rotated as indicated in FIG. 12B. When axle 365 is rotated, substantially flat surface 430 of notch portion 370 interacts with an upper inside surface 435 (not shown is this figure) of the mating slot 410. Flat surface 430 extends across the full width W (in this case the diameter of axle 365) where the flat surface intersects with notch face 440 that extends in a perpendicular direction from flat surface 430.

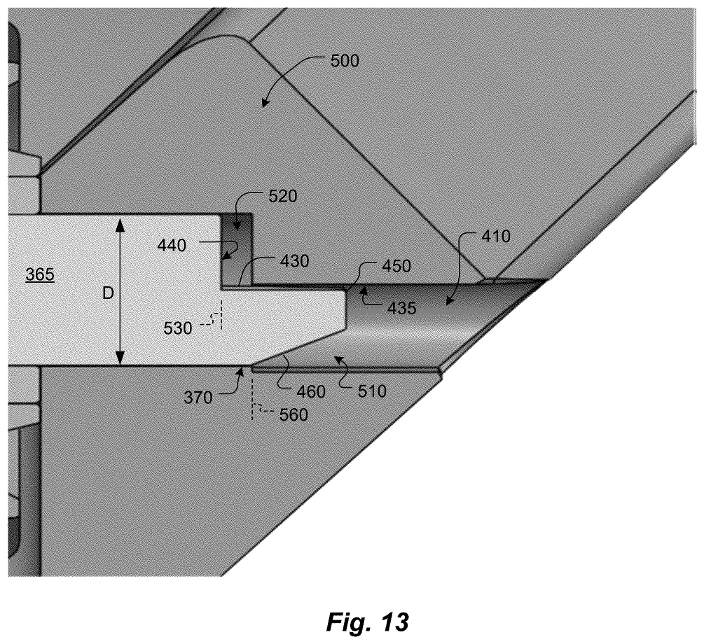

The length of the notched portion 370, and its flat surface 430, extend in the longitudinal direction of axle 365, i.e. in the direction of axis 420, until notch end 450, which in this case, is in the form of a flat semi-circular surface perpendicular to flat surface 430 and parallel to notch face 440. Notched portion 370 also includes an outer curved surface 460 extending away from and along the length of the substantially flat surface 430. Along the length of the notched portion 370, the edges 470a and 470b of flat surface 430 are tapered or chamfered, so the outer curved surface 460 is likewise tapered. The tapering/chamfering of the outer curved surface is also included in a direction perpendicular to the flat surface 430. This allows the notched portion 370 to be easily guided into mating slot 410. Tapering of the outer curved surface 460 in a direction perpendicular to flat surface 430 is better depicted in FIG. 13.

In FIG. 13, there is shown a cross-sectional view of the end of axle 365 which includes notched end portion 370 installed in mounting mechanism 500. Mounting mechanism 500 includes mating slot 410 configured to snuggly receive and hold notched end portion 370 in place, with flat surface 430 of notched end portion 470 mated face-to-face with the upper inside surface 435 of mating slot 410. The tapered and curved outer surface of notched end portion 460 (which may be angled at 20-30 degrees, preferably 23 degrees), once it has helped guide the axle 365 into mating slot 410, is not in contact with the inner surface of mating slot 410 and there is a gap 510 formed therein.

Mounting mechanism 500 also includes a larger cylindrical slot 520, only slightly larger than the diameter of axle 365, which slot is configured to snuggly receive and hold in place the full diameter of axle 365 when notched portion 370 is inserted in mating slot 410. The portion of axle 365 in cylindrical slot 520 will bear most of the forces from the mecanum wheel when the wheel is mounted on a vehicle. The notched portion 370 will primarily bear any rotational force being applied to the axle 365.

As shown in FIG. 13, the length of the cylindrical slot 520 and the length of the notch portion 370 of axle 365 will be application specific; however, the length of notch portion 370 may be limited to the required length to provide sufficient resistance to the rotation of axle 365 when it interacts with inner surface 435 of mating slot 410. Typically, the length of the notched portion 370, which extends from position 530 along the length of the axle to notch end 450, should be a small fraction (e.g. equal to or less than 5%) of the overall length of axle 365 to ensure sufficient bearing surface area. The full diameter of axle 365 is disposed into most of the length of cylindrical slot 520, while leaving a gap (shown in FIG. 13) to account for tolerances and to allow for preloading of the roller. Where the full radius of axle 365 ends, at position 560 proximate the entrance to mating slot 410, the tapering/chamfering begins. The length along the axle of the tapered part of the notched end portion 470 from notch end 450 to position 560 may be approximately 3% of the overall axle length.

As noted above, the ball bearings and other components 390 generally depicted in FIGS. 12A and B are more clearly depicted in FIGS. 14-17 and described in detail below. Although not required for the axle designs in FIGS. 8 and 11 described above, the roller assembly 380 has a ruggedized design well suited for larger/heavier vehicles, including robots with larger support structures designed to carry heavier payloads.

Referring to FIG. 14, there is shown a cross-sectional perspective view of roller assembly 380, which includes an elongated roller surface or roller over-mold 600, having a center cavity 385 and an opening at each end. Within center cavity 385 of roller surface 600 there is disposed an elongated roller core 610 having a length approximately equal to the length of roller surface 600. The roller core 610 has an outer surface which is in contact with the inner surface of roller surface 600 along its length. Roller core 610 includes a cylindrical cavity at each end aligned with an opening of the center cavity 385. The cylindrical cavities have relatively large diameters, i.e. nearly equivalent to the diameter of the roller core 610, leaving thin roller core end portions 620a and 620b, at the openings of each end. Roller core 610 has a central region between the cylindrical cavities at each end of the roller core and disposed therein is a central cylindrical cavity 630 having a diameter much smaller than its length. The central cylindrical cavity spans between and is open to the two cylindrical cavities at each end of the roller core 610. In the central region of the roller core 610 there is a thicker roller core portion 635 through which the central cylindrical cavity 630 is disposed.

Within the cylindrical cavities at each end of the roller core 610 are disposed first bearing structure 640a and second bearing structure 640b. The bearing structures are cylindrical in shape and have cylindrical cavities 645a and 645b with openings at each end. The cylindrical cavities of the bearing structures 645a and 645b and their openings are aligned with the central cylindrical cavity 630 to receive an axle (not shown) inserted therethrough.

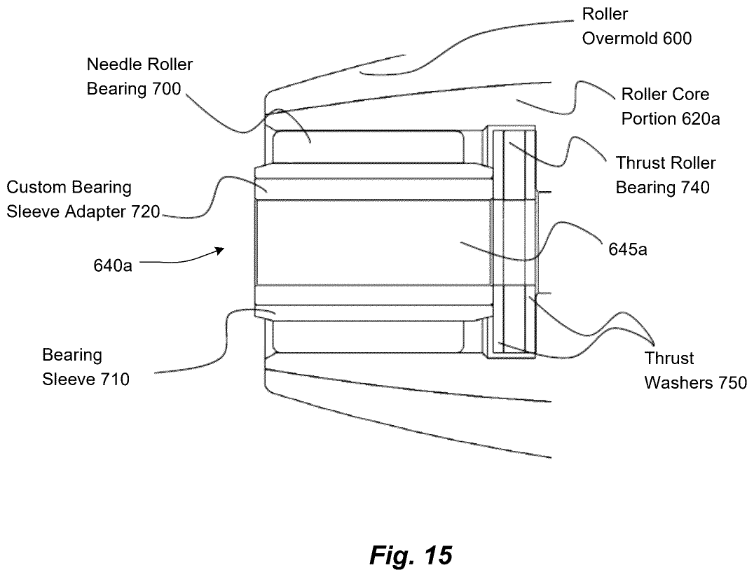

Referring now to FIG. 15, there is shown an enlarged cross-sectional view of first bearing structure 640a disposed within the cylindrical cavity defined by the opening in roller core portion 620a around which is disposed roller surface or over-mold 600. Second bearing structure 640b is designed in the same way as bearing structure 640a. First bearing structure 640a includes a needle bearing 700 and a needle bearing sleeve 710, which sleeve would normally be in contact with an axle disposed through cylindrical cavities 645a. A unique aspect of this bearing structure is that the needle bearing is oversized for the size of the axle, such that there is a gap between the outer surface of the axle and the inner surface of the bearing sleeve 710. To account for this gap, there is provided a needle bearing sleeve adapter 720 having a thickness to bridge the gap between the outer surface of the axle and the inner surface of the bearing sleeve. Needle bearings are typically made for a particular size axle. However, in certain applications, a needle bearing sized for a particular axle is not sufficient to support the load requirements, even though the axle is perfectly well suited for the application. Here, the appropriate axle size may be used, while the needle bearing can be upsized to handle the higher load requirements by including the appropriately sized bearing sleeve adapter 720.

Another unique aspect of this bearing structure is that in combination with the needle bearing 700, there is included a thrust bearing 740 mounted on the inside of needle bearing 700, i.e. further inside the cylindrical cavity at each end of the roller core 610 than the corresponding needle bearing. The thrust bearing 740 is sandwiched between two thrust washers 750. The placement of the needle bearing relative to the thrust bearing to support greater vehicle weight using mecanum wheels is a unique design. By placing the needle bearings 640a/640b at the ends of roller 380, moment loading on the axle 365 is reduced which thereby allows an axle of smaller size to be used versus an application where the needle bearings are mounting deeper into the roller core 610, resulting in greater moment forces.

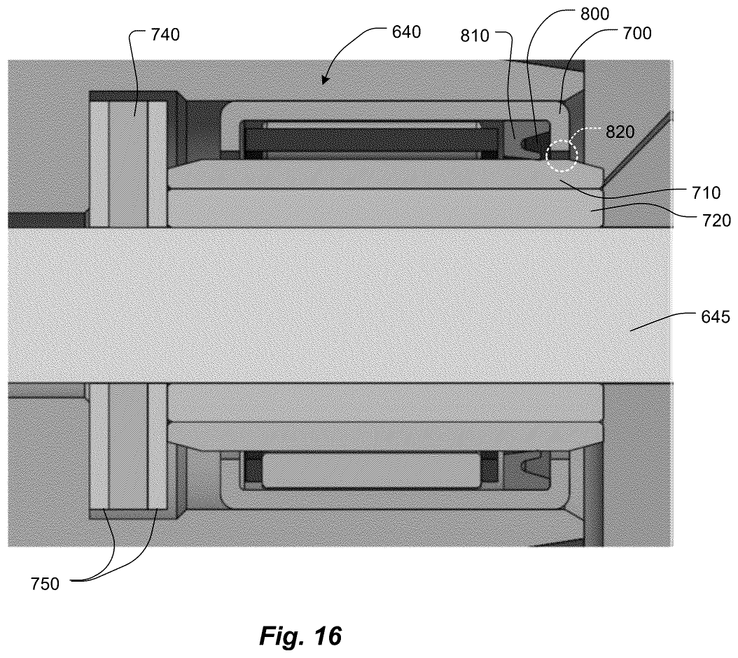

A further unique aspect of the bearing structure of this disclosure is depicted in FIG. 16 where additional detail of the internal structure of needle bearing 700 is shown as compared to that shown in FIG. 15. Other aspects of the bearing structure 640 are the same, including the needle bearing sleeve 710, the needle bearing sleeve adapter 720, as well as the thrust bearing 740 and thrust washers 750. The additional detail shown is internal to the needle bearing where a lip seal 800 is shown seated in the needle bearing housing 810. This seals a gap 820 which, if not filled by the seal 800, would allow dust and other particulate matter to enter the needle bearing 700 and the thrust bearing 740 via the bearing sleeve adapter 710 outer diameter surface. However, since this seal is provided on the needle bearing and the needle bearing is outside of the thrust bearing in the cavity, a single seal blocks dust and particulate matter from both the needle bearing 700 and the thrust bearing 740.

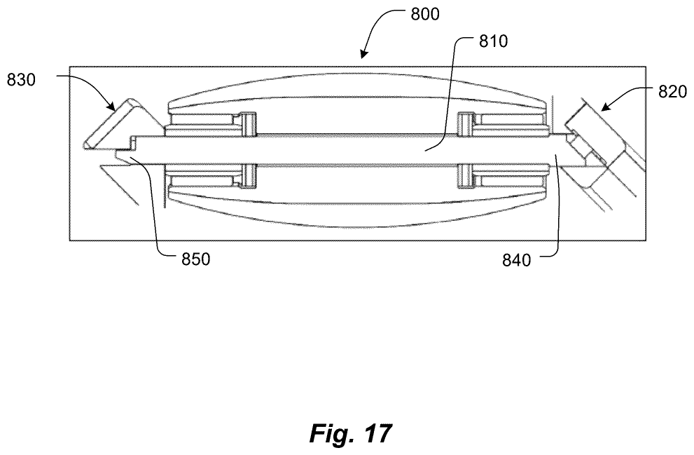

A ruggedized roller assembly 800, FIG. 17, which has the design described above with regard to FIGS. 14-16, may be used in conjunction with axle 810 and mounting mechanisms 820 and 830. Axle 810 in this example includes a first axle end portion 840 with an angled tip portion mounted in a mounting mechanism 820 like that shown in FIGS. 4 and 5. Axle 810 may include a second axle end 850 with a notched end portion mounted in a mounting mechanism 830 like that shown in FIGS. 12A and B. It should be noted that the ruggedized roller assembly 800 may be used with any type of axle with or without the above-described end portions.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A mecanum wheel, comprising:
a first wheel frame having a circumference and a plurality of first mounting mechanisms spaced about the circumference,
a second wheel frame having a circumference and a like plurality of second mounting mechanisms spaced about the circumference; each of the plurality of second mounting mechanisms having a corresponding first mounting mechanism;
a plurality of roller assemblies, each having:
a roller body with an outer surface and a central region;
an axle disposed in and extending in an axial direction through the central region, the axle having a first end connected to one of the first mounting mechanisms of the first wheel frame and having a second end connected to the corresponding second mounting mechanisms of the second wheel frame; and
wherein the second end of each axle includes a notched portion.

2. The mecanum wheel of claim 1, wherein each notched portion has a length extending from a first position along a length of the axle to the second end of the axle.

3. The mecanum wheel of claim 2, wherein the length of the notch portion is equal to or less than 5% of a length of the axle.

4. The mecanum wheel of claim 2, wherein the notched portion includes a substantially flat surface extending along the length of the notched portion and across a diameter of the axle at the first position and wherein a center of the substantially flat surface at the first position is positioned at a longitudinal axis of the axle.

5. The mecanum wheel of claim 4, wherein the notched portion has a notch depth extending radially from the center of the substantially flat surface at the first position to an outside surface of the axle.

6. The mecanum wheel of claim 5, wherein the notch depth is equal to a radius of the axle.

7. The mecanum wheel of claim 4, wherein the notched portion includes an outer curved surface extending away from and along the length of the substantially flat surface; and
wherein the outer curved surface is chamfered along at least a portion of the length of the notched portion.

8. The mecanum wheel of claim 4, wherein each second mounting mechanism includes an internal hollow region to receive the second end of the axle.

9. The mecanum wheel of claim 8, wherein the internal hollow region includes a first hollow section which is cylindrical in shape and has a diameter substantially equal to the diameter of the axle and a second hollow section has an interior surface shaped to receive an exterior surface of the notched portion of the axle.

10. The mecanum wheel of claim 9, wherein when the notched portion of the axle is disposed in the second hollow section, a portion of the axle is disposed in the first hollow section; and wherein the substantially flat surface of notched end portion is mated face-to-face with a substantially flat surface portion of the interior surface of the second hollow section.

11. The mecanum wheel of claim 1, wherein the first end of each axle includes an angled tip portion with a substantially flat surface.

12. The mecanum wheel of claim 11, wherein each first mounting mechanism includes an elastic compression piece having a first surface disposed on the substantially flat surface of the angled tip portion of the first end of the axle.

13. The mecanum wheel of claim 12, wherein each first mounting mechanism includes a cover piece in contact with a second surface of the compression piece and configured to compress the compression piece against the substantially flat surface of the angled tip portion of the first end of the axle.

14. The mecanum wheel of claim 13 wherein the substantially flat surface of the angled tip portion of the first end of the axle is parallel to an external surface the first wheel frame and the cover piece is mounted on the external surface of the first wheel frame.

15. The mecanum wheel of claim 1 further including a first bearing structure mounted in a first cavity at a first end of the roller body and a second bearing structure mounted in a second cavity at a second end of the roller body, wherein the first and second bearing structures, include:
a needle roller bearing disposed about the axle with an inner surface spaced from an outer surface of the axle in a radial direction forming a gap between the inner surface of the needle roller bearing and the outer surface of the axle;
a sleeve adapter disposed in the gap about the axle between and in contact with the inner surface of the needle roller bearing and the outer surface of the axle; and
a thrust roller bearing disposed about the axle adjacent to and inside of the needle roller bearing in an axial direction, with an inner surface in contact with the outer surface of the axle.

16. A mecanum wheel comprising:
a first wheel frame having a circumference and a plurality of first mounting mechanisms spaced about the circumference,
a second wheel frame having a circumference and a like plurality of second mounting mechanisms spaced about the circumference; each of the plurality of second mounting mechanisms having a corresponding first mounting mechanism;
a plurality of roller units, each having:
a roller body with an outer surface and a central region; wherein the central region includes a first cavity at a first end of the roller body, a second cavity at a second end of the roller body;
an axle extending in an axial direction through the roller body, including through the first cavity and the second cavity, and being connected at a first end to one of the first mounting mechanisms of the first wheel frame and at a second end to the corresponding second mounting mechanisms of the second wheel frame; and
a first bearing structure mounted in the first cavity and a second bearing structure mounted in the second cavity, the first and second bearing structures, including:
a needle roller bearing disposed about the axle with an inner surface spaced from an outer surface of the axle in a radial direction forming a gap between the inner surface of the needle roller bearing and the outer surface of the axle;
a sleeve adapter disposed in the gap about the axle between and in contact with the inner surface of the needle roller bearing and the outer surface of the axle; and
a thrust roller bearing disposed about the axle adjacent to and inside of the needle roller bearing in an axial direction, with an inner surface in contact with the outer surface of the axle.

17. The mecanum wheel of claim 16, wherein the first bearing structure includes a first lip seal disposed about a circumference of a first end of the needle roller bearing proximate an opening of the first cavity and wherein the second bearing structure includes a second lip seal disposed about a circumference of a first end of the needle roller bearing proximate an opening of the second cavity.
